(19) United States
(12) Patent Application Publication
(10) Pub. No.: US 2004/0123181 A1
(43) Pub. Date: Jun. 24, 2004

(54) Self-repair of memory arrays using preallocated redundancy (PAR) architecture

(76) Inventors: Nathan I. Moon, Austin, TX (US); Richard K. Eguchi, Austin, TX (US); Sung-Wei Lin, Austin, TX (US)

Correspondence Address: Michael C. Barrett, Esq., FULBRIGHT & JAWORSKI, L.L.P., Suite 2400, 600 Congress Avenue, Austin, TX, 78701, US

(21) Appl. No.: 10/327,641

(22) Filed: Dec. 20, 2002

(51) Int. Cl. H04L 1/22

(52) U.S. Cl. 714/13

(57) ABSTRACT

Methods and apparatus for self-repairing non-volatile memory using a PreAllocated Redundancy (PAR) architecture. In a representative embodiment, the non-volatile memory includes a block, a memory subblock, a redundancy subblock having a size equal to the size of the memory subblock, a comparator coupled to the block, a fail latch circuit coupled to the block, and a fuse coupled to the block. The comparator is configured to identify a failure within a particular memory subblock by comparing expected data with read data. The fail latch circuit is configured to determine an address of the particular memory subblock. The fuse is configured to cause the particular memory subblock to be replaced with the redundancy subblock, thereby repairing the non-volatile memory.

### BACKGROUND OF THE INVENTION

1. Field of the Invention

The invention relates generally to the self testing and repair of memories. More particularly, the invention relates to testing and repair of nonvolatile memories (NVMs) using a preallocated redundancy (PAR) architecture.

2. Discussion of Related Art

As memory sizes increase, the time spent in testing memory increases as well. This increase, in turn, represents an additional cost for memory manufacturers. Accordingly, the ability to efficiently test memory is important not only to ensure that memory is functioning properly, but also to save costs.

Generic built-in self test (BIST) for memory arrays has been utilized in the art to test memory arrays. In the generic BIST architecture, memory is tested by a BIST block that supplies a series of patterns to the memory (e.g., march tests or checkerboard patterns). The BIST block then compares outputs against a set of expected responses. Because the patterns are highly regular, the outputs from the memories can be compared directly to reference data using a comparator, ensuring that an incorrect response from the memory will be flagged as a test failure.

Data from the BIST block is typically output and processed to determine the exact location of the memory defects. With the defective locations known, an external repair device employing a laser may be used to accomplish the actual repair of the memory. These processing and repair steps often represent a complicated, time-consuming process. Specifically, these steps typically require high-intelligence (e.g., a dedicated built-in redundancy analysis (BIRA) logic unit) and employ various complicated external equipment.

Built In Self Repair (BISR) refers to general techniques designed to overcome some of the shortcomings associated with BIST and external, laser-based repair. BISR takes advantage of an on-chip processor and redundancy analysis logic to “route-around” bad memory bits rather than using expensive and slow lasers to burn out bad memory rows or columns. Repair typically involves routing around a faulty memory location with either a redundant row of memory, a redundant column of memory, or a redundant single bit of memory, in accordance with the redundancy logic scheme used.

Although conventional BIST and BISR techniques have exhibited utility in testing and repairing memories, room for significant improvement remains. For instance, better testing and repair methodologies are needed so that BIST and BISR can more efficiently repair defects “on the fly” without employing an overly-complicated redundancy analysis unit. Additionally, more flexible testing techniques are required so that different testing variables can be easily tuned and adjusted to more effectively identify (and eliminate) faulty data bits.

Further, better testing and repair methodologies are needed so that BIST and BISR can be flexibly and efficiently applied to the testing and repairing of non-volatile memories (NVMs), which traditionally have not been able to take advantage of BIST combined with BISR for at least three broad reasons. First, non-volatile memories are typically implemented with various memory cell circuit designs and use different processing technologies, making it difficult or impossible to apply conventional testing techniques. Second, traditional testing techniques do not allow a user to efficiently tune and control testing variables; consequently, faulty data bits are not always effectively located and identified for eventual repair. Third, non-volatile memories come in many different types, such as flash (bulk erased) or electrically erasable (byte/word erasable), each type involving different erasing, programming, read and stress algorithms. These different types of memory and different memory algorithms further complicate testing parameters.

The shortcomings referenced above are not intended to be exhaustive, but rather are among many that tend to impair the effectiveness of previously known techniques concerning self-test and repair; however, those mentioned here are sufficient to demonstrate that methodology appearing in the art have not been altogether satisfactory and that a significant need exists for the techniques described and claimed in this disclosure. In particular, a need exists for new built-in test and repair techniques that do not rely upon overly-complicated logic units and that utilize an architecture suitable for use even in non-volatile memories.

### SUMMARY

In one respect, the invention involves a non-volatile memory. The non-volatile memory includes a block, a memory subblock, a redundancy subblock having a size equal to the size of the memory subblock, a comparator coupled to the block, a fail latch circuit coupled to the block, and a fuse coupled to the block. The comparator is configured to identify a failure within a particular memory subblock by comparing expected data with read data. The fail latch circuit is configured to determine an address of the particular memory subblock. The fuse is configured to cause the particular memory subblock to be replaced with the redundancy subblock, thereby repairing the non-volatile memory.

In another respect, the invention involves a method of self-test and repair of a non-volatile memory. An expected threshold voltage property is compared to a read threshold voltage property using a comparator to identify a failure within a particular memory subblock. An address of the particular memory subblock is determined using a fail latch circuit, and the particular memory subblock is replaced with the redundancy subblock using a fuse, thereby repairing the non-volatile memory.

Other features and associated advantages will become apparent with reference to the following detailed description of specific embodiments in connection with the accompanying drawings.

### BRIEF DESCRIPTION OF THE DRAWINGS

The techniques of this disclosure may be better understood by reference to one or more of these drawings in combination with the detailed description of illustrative embodiments presented herein.

FIG. 1 is a graph illustrating techniques for self-testing an NVM.

FIG. 2 is a flowchart illustrating techniques for self-test and repair, in accordance with embodiments of the present disclosure.

FIG. 3 is a block diagram illustrating hardware for implementing self-test and repair, in accordance with embodiments of the present disclosure.

### DESCRIPTION OF ILLUSTRATIVE EMBODIMENTS

Embodiments of the present disclosure make use of a testing/repair architecture termed the PreAllocated Redundancy (PAR) architecture. As illustrated below, this architecture is particularly well-suited for providing flexible and efficient self test/repair techniques, even when applied to NVMs. Embodiments of this disclosure focus upon the use of the PAR architecture for self-test and repair of NVMs (e.g. the self-repair of a flash EEPROM), although it will be understood that individual or combined techniques from the disclosure may be applied readily to other types of memory.

Embodiments of the present disclosure may be used in processors with embedded nonvolatile memories and stand alone nonvolatile memories. As memories such as flash arrays become faster and contain higher densities, techniques of this disclosure may become especially beneficial, as will be apparent to those having ordinary skill in the art.

Before explaining the PAR architecture and its applicability to the self-repair of NVMs, it is first useful to explain how NVMs may be flexibly tested, (as opposed to repaired), according to embodiments of this disclosure. FIG. 1 aids that explanation.

Self-test of NVMs

Memory bits of NVMs are typically set by changing their threshold voltage (V_{T}). Writing to an NVM is accomplished by stressing the bits or shifting V_{T} instead of writing a hard one or zero to the bit.

Errors or faults in NVMs may be found through self-testing. One suitable testing technique begins by attempting to initialize NVM bits to predetermined threshold voltages. Each bit's subsequent V_{T} value is then read, and faulty data bits are located by identifying those whose measured V_{T} does not match the initialization value.

Another suitable testing technique begins by writing data or stressing an NVM by shifting the V_{T} of an initialized bit, the result of which is predictable. A “maverick” bit, or failed bit, can be identified as one whose V_{T} did not shift enough or shifted too much.

In general, other suitable testing techniques may utilize different bias conditions (e.g., stress, program, erase), different pulse widths applied to a memory-under-test, different numbers of pulses applied to a memory-under-test, different V_{T} initialization values, and/or an identification of different acceptable shifts in V_{T.}

FIG. 1 illustrates a maverick bit identified by one or more of the suitable testing techniques described above. Curve 100 shows an initialized V_{T} curve. Its leading edge is shown as 103. Curve 105 is an expected V_{T} curve after the NVM has been stressed. Its leading edge is shown as 108. Curve 110 represents a maverick bit exhibiting an unacceptable shift. Its leading edge is shown as 110. This maverick bit represents a type of NVM bit failure requiring replacement.

In embodiments of this disclosure, a user can increase the flexibility of such testing steps by inputting, and thereby controlling, variables for use in the testing sequence or flow. For instance, in one embodiment, a user may dictate bias conditions, testing pulse widths, the number of test pulses to be used, the initial V_{T} level, and/or the allowable shift in the V_{T} level. By dictating such variables, self-testing of an NVM may be made significantly more flexible. For instance, variables may be tuned in an attempt to more efficiently locate particular types of maverick bits. If it is known that certain maverick bits are not being efficiently located using a first set of variables, those variables may be tuned to improve the testing efficiency.

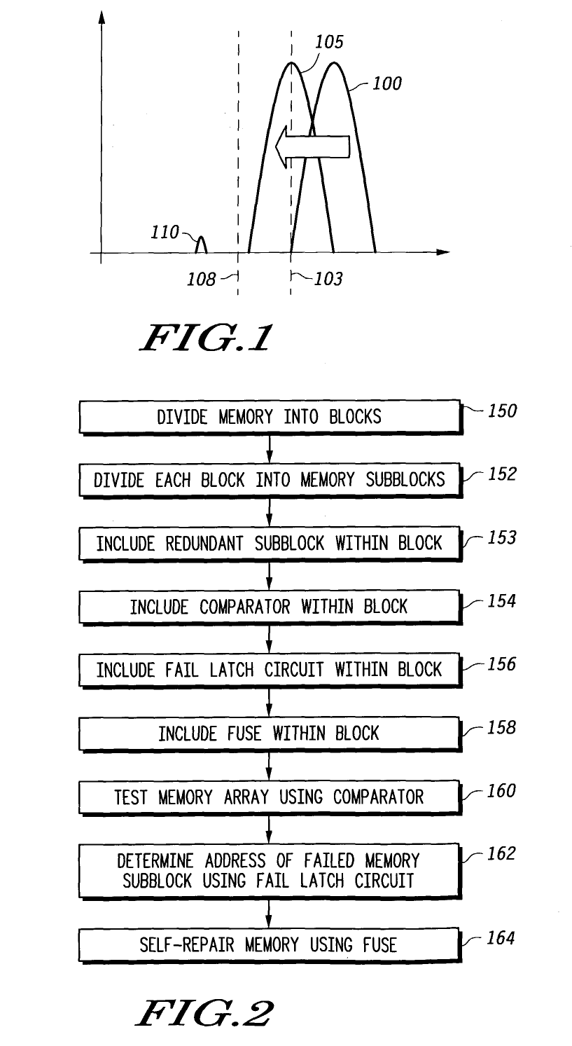

In one embodiment, the use of flexible testing variables is accomplished, in part, using test registers including user-input variables and a state machine, as explained in relation to FIG. 2, discussed below.

Overview of the PAR Architecture for Self-test and Self-repair

The PAR architecture splits a memory array into a plurality of different blocks, or subdivisions. Each block, in turn, is further divided into a plurality of memory subblocks, or further subdivisions (e.g., one or more columns, one or more rows, or one or more row/column combinations). In addition to the plurality of memory subblocks, one or more redundancy subblocks (together, forming a redundancy block) are present. The size of a memory subblock matches that of a redundancy subblock. Redundancy and memory subblocks may be based on row and/or column arrangement (giving rise to row and/or column “redundancy”).

Besides the one or more redundancy subblocks and the plurality of memory subblocks, each individual block is coupled to a comparator, a fail latch circuit, and fuses. The operation of each of these elements will be detailed below. In general, however, the comparator facilitates self-test by comparing expected data with measured data to identify a memory failure. The fail latch circuit allows test information to be used for the repair process by generating (a) the address (column and/or row) of a memory subblock housing a memory failure and (b) fuse enable bit data. The fuses facilitate repair by replacing the address of the memory subblock housing a memory failure with that of a redundant subblock. As will be understood by those having ordinary skill in the art with the benefit of this disclosure, elements such as the comparator and/or fail latch circuit can include, in whole or in part, logic circuits.

In order to accomplish a repair under the PAR architecture, one simply requires the output of the comparator at the block level along with the address of the memory subblock that contained one or more faulty memory bits, as stored by the fail latch circuit. This fail data can then be used for programming appropriate fuses in a self-repair flow, under the control of BIST, so that the fuse effectively causes the failed memory subblock to be routed to a redundant subblock. Or, in another embodiment, the fail data may be sent to an external storage (off-chip storage, such as registers or other NVMs) by serial or parallel operation for external fuse tasks.

The PAR architecture ensures that fails in one block do not affect the repair of another block since repairs are taken care of locally within each block. The PAR architecture, however, also means that failures in more than one memory subblock may not be repaired. In particular, in an embodiment using only one redundant subblock within each block, only one failed memory subblock may be repaired. If an additional memory subblock is found to be faulty, there will not be a viable replacement since the redundant subblock has already been used.

Again, subblocks of the PAR architecture can be based on column and/or rows, and the PAR architecture may be set up to enable its redundancy subblocks to replace only memory subblock rows, memory subblock columns, or both memory subblock rows and columns in succession. If both column and row redundancy is used, repair may be started with turning on one of the preferred redundancy (e.g. rows). After fuse programming and activation take place to route around a failed memory subblock, the other redundancy (e.g. columns) may be continued. Such an embodiment may provide for better repair coverage.

Exemplary Operation of the PAR Architecture for Self-test and Self-repair

In an exemplary embodiment, the PAR architecture works as illustrated in FIG. 2 to achieve self-test and self-repair of an NVM, such as but not limited to a flash EEPROM.

In step 150, a memory array is divided into a plurality of blocks. In step 152, each block is further divided into a plurality of memory subblocks and includes, in an exemplary embodiment, one redundancy subblock (step 153). Alternatively, the redundancy subblock may be separate from, but in operative relation with, a block. In other embodiments, more than one redundancy subblock may be present. In a representative embodiment, the size of a memory subblock matches the size of a redundancy subblock.

In step 154, a comparator is included within each block, or alternatively coupled to each block. In step 156, a fail latch circuit is included in each block, or alternatively coupled to each block. In step 158, a fuse is included in each block, or alternatively coupled to one or more blocks.

In step 160, the memory array is tested to identify one or more failures within different subblocks. In general, this testing step may involve the comparison of expected data on a memory bit to the measured or read data actually present. For each block, the comparator may make that comparison. If the expected data does not match the measured or read data, a failure is identified. As will be understood by those having ordinary skill in the art by a “match” in expected data and the measured or read data may entail a range of acceptable values, and strict equality is not always required.

In an embodiment in which the memory array corresponds to a NVM, the testing step may involve the initializing of a memory bit to a particular threshold voltage followed by the reading of the bit to ensure that the initialization value is present. In such a test, the expected data of course refers to the initialization value. In other embodiments, a different write/read test may be used. In other embodiments, the expected data may correspond to a particular threshold voltage shift, and the comparator may compare that shift to the actual shift read or measured. As will be apparent to those having ordinary skill in the art, many different other expected/read data sets may be contemplated, as is known in the art, to identify if a memory bit has failed.

In step 162, an address of a failed memory subblock (i.e. the subblock housing a failed memory bit) is determined. The fail latch circuit may generate this address. The address, in turn, may be stored in one or more appropriate modules, such as a fuse write control logic module, which will be discussed below. With a failure identified along with a corresponding address, self-repair may commence.

In step 164, self-repair is accomplished. The failed memory subblock is replaced with the redundancy subblock within the block. The redundancy subblock's size matches that of the failed subblock. The replacement may be done by address replacement using the fuse. In particular, the address of the failed subblock may be replaced with that of the redundancy subblock.

As will be understood by those having ordinary skill in the art, steps 160, 162, and 164 may be performed during manufacture or during any stage of operation of the memory in which it is desired to test/repair the device.

Exemplary Implementation of the PAR Architecture for Self-test and Self-repair

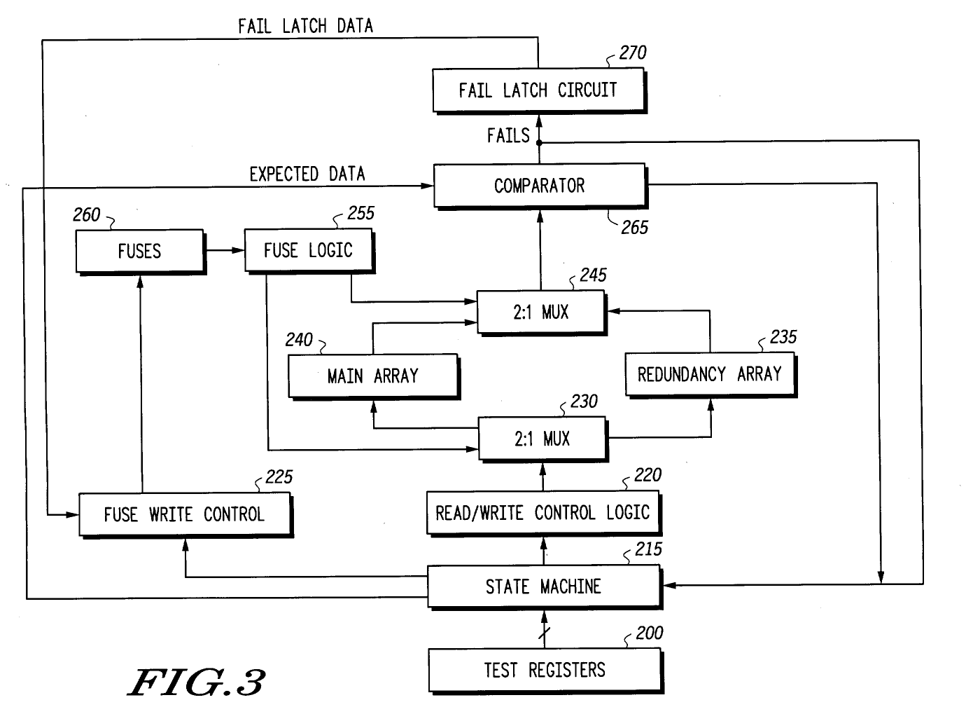

In FIG. 3, a specific hardware embodiment of the invention is shown that is suitable to accomplish the self-test and repair functionality described herein.

Those having ordinary skill in the art will recognize that many different hardware layouts may be used to accomplish the functionality described in this disclosure. Accordingly, the embodiment of FIG. 3 is exemplary only. Although FIG. 3 illustrates direct connections between elements, it will be understood that intermediate elements may be present as well. It will also be understood that one or more elements may be consolidated or otherwise modified, while still achieving the same functionality.

Although the relation of particular elements is self-explanatory by inspection of FIG. 3, this paragraph describes those relationships in words. Test registers 200 are coupled to state machine 215. State machine 215 is coupled to comparator 265, fuse write control logic module 225, and read/write control logic module 220. Comparator 265 is coupled to a 2-to-1 multiplexer (MUX) 245 and a fail latch circuit 270. Fuse write control logic module 225 is coupled to fuses 260 and fail latch circuit 270. Read/write control logic module 220 is coupled to a 2-to-1 MUX 230, which is coupled to fuse logic block 255. Fuse logic block 255 is coupled to fuses 260 and to the 2-to-1 MUX 245. The 2-to-1 MUX 230 is coupled to both main array 240 and redundancy array 235, both of which are coupled to the 2-to-1 MUX 245. The 2-to-1 MUX 245 is coupled to the comparator 265.

In operation, state machine 215 receives inputs from test registers 200, which in one embodiment may include variables for BISR pulses/signals such as pulse width, bias conditions, number of pulses, threshold voltage levels, an allowable shift in a threshold voltage level, and/or any general algorithm controlling BISR signals. These variables may advantageously be entered by the user, providing for great flexibility in self-test. In particular, variables may be tuned to more efficiently identify particular types of failures. Similarly, variables may be purposefully tuned to act as a type of self-test filter, identifying certain types of failures but not others.

Based upon the inputs from test registers 200, state machine 215 determines or looks-up corresponding expected data for self-test of the memory. “Expected” data simply refers to data (or a data range) that is expected to be read or measured from normal (as opposed to failed) memory. In one embodiment, inputs from test registers 200 may define a particular expected threshold voltage property, such as a particular threshold voltage shift expected of normal memory. In another embodiment, inputs from test registers 200 may define a different expected threshold property, such as a particular threshold voltage amplitude. Those having ordinary skill in the art will recognize that any number of properties may form the basis of expected data.

State machine 215 passes the expected data to the comparator 265, for eventual comparison with actual read or measured data. State machine 215 also sends control signals to the fuse write control logic module 225 and to the read/write control logic module 220 to regulate the reading of NVM bits.

Read/write control logic module 220 sends signals to the 2-to-1 MUX 230 denoting addresses of bits to be tested. Based on the signals from read/write control logic module 220 and information on fuses 260, from the fuse logic block 255, the 2-to-1 MUX 230 determines which array locations in main array 240 and redundancy array 235 will be written-to and writes data to the selected array locations. The selected locations in main array 240 and redundancy array 235 may be filled with a predefined or user-selected test pattern. The 2-to-1 MUX 245, which operates with information on fuses 260 from fuse logic block 255, determines which array locations in main array 240 and redundancy array 235 will be read and reads data from the selected locations.

Data read from the main array 240 and the redundancy array 235 are sent to the comparator 265, which compares this data against the expected data that is passed from state machine 215. If the two sets of data are the same (or within an acceptable range of difference), the process of reading and comparing data repeats until the last address of the NVM has been read and compared, as determined by state machine 215.

If the two sets of data differ to an unacceptable extent, then a failure is identified. Data detailing the difference (failure data) is sent to the fail latch circuit 270, which determines which bit(s) in a particular subblocks are in error. The addresses of the failed bits are generated at fail latch circuit 270 and passed to fuse write control block 225, which programs fuses 260 as needed to reflect the self-repair, as directed by the state machine 215. State machine 215 determines the location of the redundancy subblock to be used within the block, and whether that redundancy subblock is free. If the redundancy subblock is available, fuse write control block 225 sends a write signal to fuses 260 to replace the address of the failed memory subblock with the address of the redundancy subblock, thereby accomplishing self-repair.

Put another way, when a failed memory subblock is replaced by a redundancy subblock, fuses 260 are programmed to replace the address of the failed memory subblock with the address of the redundancy subblock. The next time a read or write function is called, the address of the redundancy subblock will be accessed where the address of the failed memory subblock would have been accessed, thus effectively replacing the failed memory subblock with the redundancy subblock.

All timing sequences for timing the test and repair processes described above may be internally controlled by state machine 215 through synchronization and voltage switching. Test time throughput may be maximized by eliminating the overhead of tester/DUT and repairer/DUT handshaking for synchronization, current measurements, and voltage.

The techniques of this disclosure allow for the collection of encoded fail data in real time without the help of BIRA since the PAR architecture removes the need for complicated redundancy analysis, while still allowing for the repair of multiple fail locations for high repair coverage. Moreover, the techniques of this disclosure may be incorporated into BIST since there is no need for external communication outside of the memory array.

The PAR architecture removes costs related to redundancy analysis such as costs associated with high communication bandwidth requirements, expensive external memory testing, redundancy analysis program generation, and associated engineering efforts.

Low cost test systems may be realized using these techniques, and built in self repair methodology may be contained within the DUT. Test time throughput may be maximized by eliminating the overhead of tester/DUT handshaking for synchronization, current measurements and voltage.

The terms “a” or “an” mean one or more than one unless their context explicitly contradicts such interpretation. The term “plurality” means two or more than two. The term “coupled” means connected, although not necessarily directly, and not necessarily mechanically.

All the disclosed embodiments of the invention disclosed herein can be made and used without undue experimentation in light of the disclosure. It will be manifest that various substitutions, modifications, additions and/or rearrangements of the features of the invention may be made without deviating from the spirit and/or scope of the underlying inventive concept It is deemed that the spirit and/or scope of the underlying inventive concept as defined by the appended claims and their equivalents cover all such substitutions, modifications, additions and/or rearrangements.

We claim:

1. A non-volatile memory comprising:
a block;
a memory subblock within the block;
a redundancy subblock having a size equal to the size of the memory subblock;
a comparator coupled to the block, configured to identify a failure within a particular memory subblock by comparing expected data with read data;
a fail latch circuit coupled to the block, configured to determine an address of the particular memory subblock; and
a fuse coupled to the block, configured to cause the particular memory subblock to be replaced with the redundancy subblock, thereby repairing the non-volatile memory.

2. The non-volatile memory of claim 1, further comprising a test register coupled to the block and coupled to the comparator, the test register configured to store a test variable input by a user, the test variable serving as a basis for the expected data.

3. The non-volatile memory of claim 2, the test register configured to store a user-input bias condition, a testing pulse width, a number of test pulses, an initial threshold voltage level, or an allowable shift in a threshold voltage level.

4. The non-volatile memory of claim 1, the non-volatile memory comprising a flash EEPROM.

5. The non-volatile memory of claim 1, further comprising a processor in operative relation with the non-volatile memory.

6. A non-volatile memory comprising:
means for reading data from a memory subblock;
means for comparing the data with expected data;
means for identifying a failed memory subblock when the data does not match the expected data; and
means for replacing the failed memory subblock with a redundant subblock, thereby repairing the non-volatile memory.

7. The non-volatile memory of claim 6, further comprising means for basing the expected data on a test variable input by a user.

8. The non-volatile memory of claim 7, the test variable comprising a user-input bias condition, a testing pulse width, a number of test pulses, an initial threshold voltage level, or an allowable shift in a threshold voltage level.

9. The non-volatile memory of claim 6, the non-volatile memory comprising a flash EEPROM.

10. The non-volatile memory of claim 6, further comprising a processor in operative relation with the non-volatile memory.

11. A method of self-test and repair of a non-volatile memory, comprising:
comparing an expected threshold voltage property to a read threshold voltage property using a comparator to identify a failure within a particular memory subblock;
determining an address of the particular memory subblock using a fail latch circuit; and
replacing the particular memory subblock with the redundancy subblock using a fuse, thereby repairing the non-volatile memory;
the non-volatile memory array comprising a block including a plurality of memory subblocks;
the non-volatile memory further comprising a redundancy subblock having a size equal to the size of the memory subblock; and
the non-volatile memory array being coupled to the comparator, the fail latch circuit, and the fuse.

12. The method of claim 1 , the expected threshold voltage property being based on a test variable input by a user.

13. The method of claim 12, the test variable comprising a bias condition, a testing pulse width, a number of test pulses, an initial threshold voltage level, or an allowable shift in a threshold voltage level.

14. The method of claim 11, the expected threshold voltage property comprising a shift in threshold voltage.

15. The method of claim 11, the non-volatile memory comprising a flash EEPROM.

16. The method of claim 11, the non-volatile memory being in operative relation with a processor.
